(19) United States
(12) Patent Application Publication
(10) Pub. No.: US 2014/0100319 A1
(43) Pub. Date: Apr. 10, 2014

(54) BONDING OR BINDING AGENTS FOR SOIL STABILIZATION OR MODIFICATION AND METHODS OF THEIR PREPARATION

(71) Applicant: Momentive Specialty Chemicals Inc., Columbus, OH (US)

(72) Inventor: Steven J. Wantling, Hoover, AL (US)

(73) Assignee: Momentive Specialty Chemicals Inc., Columbus, OH (US)

(21) Appl. No.: 14/044,407

(22) Filed: Oct. 2, 2013

Related U.S. Application Data
(60) Provisional application No. 61/712,014, filed on Oct. 10, 2012.

(51) Int. Cl. C09K 17/20

(52) U.S. Cl. CPC C09K 17/20
USPC 524/503

(57) ABSTRACT

Disclosed are bonding or binding compositions useful in stabilizing or modifying soil as a sub-base. Specifically, bonding or binding agent compositions of the invention include a first emulsion containing a wax, and a second emulsion containing a film forming polymer.

### FIELD OF THE INVENTION

The present invention relates to bonding or binding agents useful in stabilizing or modifying soil as a sub-base. Specifically, the present invention relates to bonding or binding compositions containing a first emulsion including a wax, and a second emulsion including a film forming polymer.

### BACKGROUND OF THE INVENTION

In the civil engineering and construction industries, soil modifiers or stabilizers are often added to aid in achieving the soil compaction needed to meet a particular project's specifications. For example, soil must be compacted and stabilized or modified prior to the placement of asphalt, concrete or aggregate to ensure it has sufficient shear strength, and not change in volume as it expands or contracts with different moisture content. Dry cement, lime or fly ash are often added to modify soil prior to compaction in order to obtain the necessary properties. However, the use of such dry products can produce toxic dusts, which restrict their use in windy conditions.

Accordingly, there is a need for a bonding or binding agents that may be combined with local soils to modify or stabilize the soil into a material that may be compressed to the desired design specification.

### SUMMARY OF THE INVENTION

In one embodiment, there is provided a bonding or binding composition, useful in modifying or stabilizing soil, which contains a first emulsion including a wax and a second emulsion including a film forming polymer.

In another embodiment, there is provided a method of preparing a bonding or binding composition, useful in modifying or stabilizing soil, which at least includes the step of combining a first emulsion containing a wax with a second emulsion containing a film forming polymer.

In another embodiment there is provided a method of stabilizing or modifying soil, which at least includes the step of adding or combining the bonding or binding composition of the invention with a least a portion of soil.

In another embodiment there is provided a stabilized or modified soil which is incorporated or contacted with the bonding or binding composition of the invention.

### BRIEF DESCRIPTION OF THE FIGURES

FIG. 1 is a Soil Proctor Curve showing Unit Weight (lbs./ft³) as a function of Water to Soil Ratio.

FIG. 2 is an Untreated Versus Treated Liquid Limit plot showing % moisture as a function of Blow Count.

FIG. 3 is a Standard CBR (California Bearing Ratio) plot showing psi and a function of Penetration (in).

FIG. 4 is a Modified (Dried) CBR plot showing psi and a function of Penetration (in).

### DETAILED DESCRIPTION OF THE INVENTION

The present invention provides bonding or binding agents useful in stabilizing or modifying soil as a sub-base. Specifically, the present invention relates to bonding or binding agent compositions containing a first emulsion comprising a wax, and a second emulsion comprising a film forming polymer.

Suitable waxes for use in the first emulsion include one or more of (1) petroleum waxes such as paraffin: fully refined waxes, semi refined waxes, scale wax, slack wax, microcrystalline wax and petrolatum; (2) Montan waxes derived from coal or lignite; (3) synthetic waxes which may include polyolefins such as polyethylene or polypropylene, silicone waxes, vinyl acetate ethylene copolymer waxes, and poly amide waxes; (4) animal waxes which include bee's wax and lanolin; and (4) vegetable waxes which may include carnauba wax, candelilla wax, jojoba and soybean wax. In one embodiment, the oil content of these waxes is typically less than about 20% by weight, and may be less than 15% by weight.

In one embodiment the wax has a melting point in the range of about 50° C. to about 70° C. In another embodiment the wax contains one or more CₙH2ₙ₊₂ hydrocarbons, where n is an integer between 18 and 42. In another embodiment the wax is a predominantly straight chain hydrocarbon having an average chain length of 20 to 30 carbon atoms. In another embodiment, the waxes are of a relatively high molecular weight, having an average chain length of C₃₂, that is a 32 carbon chain length, or greater. In another embodiment the wax has an average chain length is 32 to 45. In another embodiment the wax has an average chain length is 22 to 45.

In one embodiment, the wax is derived from lubricating oil distillates, such as, for example EXXON ProWax 561 commercially available from ExxonMobil, Irvin Tex. Waxes, known as slack waxes are petroleum waxes having an oil content of 3 to 50 wt % or perhaps 3 to 25 wt %.

The wax may comprise about 10 to about 60 wt %, about 10 to about 60 wt % or about 15 to about 45 or about 25 to about 45 wt %, with the wt % being based on the entire weight of the bonding or binding agent composition.

In one embodiment, the first emulsion may optionally include a surfactant which may be formed by the combination of an acid component and an alkaline component. The acid component may be a fatty acid having from eight to twenty four carbon atoms (a C₈ to C₂₄ fatty acid). Suitable fatty acids include, but are not limited to, lauric acid, palmitic acid, stearic acid, behenic acid, oleic acid, linoleic acid, linolenic acid and mixtures thereof. When utilized, the acid component is present in an amount of about 0.5 to 3.5 wt % based on the entire weight of the emulsion. The alkaline component may include an amine containing compound such as alkanolamine. Suitable alkanolamines include, but are not limited to diethanolamine (DEA), triethanolamine (TEA), or 2-amino-2-methyl-1-propanol (AMP), morpholine and combinations thereof. The caustic component may include an hydroxide, such as metal hydroxides. Suitable hyroxides include potassium hydroxide, magnesium hydroxide, sodium hydroxide, ammonium hydroxide and combinations thereof. When utilized, the alkaline component is present in an amount of about 0.5 to about 3 wt % based on the entire weight of the bonding or binding agent composition.

The film forming polymer suitable for use in the second emulsion may include one or more of vinyl acetate, vinyl proponate, vinyl butyrate, vinyl isobutyrate, vinyl 2-thylhexoanoate, vinyl laurate monomers or one or more of any subset thereof in an amount of about 5wt % to about 20wt %, with the wt % being based on the entire weight of the bonding or binding agent composition.

In one embodiment, the second emulsion contains a copolymer comprising a vinyl acetate monomer and a vinyl ester of a carboxylic acid monomer. The vinyl ester of a carboxylic acid monomer may be one or more of a vinyl ester of a C₂ to C₁₂ carboxylic acid, for example VeoVa-9™ or VeoVa-10™ vinyl ester of a carboxylic acid both commercially available from Momentive Specialty Chemicals Inc., Columbus Ohio. The vinyl acetate monomer may comprise about 5wt % to about 25wt %, with the wt % being based on the entire weight of the bonding or binding agent composition. The vinyl ester of a carboxylic acid monomer may comprise about 0.05wt % to about 10 wt %, with the wt % being based on the entire weight of the bonding or binding agent composition.

In another embodiment, the second emulsion may optionally include polyvinyl alcohol (PVOH). The PVOH may have a viscosity from about 1 centipoise (cps) to about 11 cps, such as from about 2.5 cps to about 4.5 cps, and may have a molecular weight (M_{w}) from about 13,000 to about 23,000. The PVOH may by hydrolyzed from at greater than 85%, such as greater than 95%, for example hydrolyzed from about 98% to 99%. The PVOH may be in the form of a solid or an aqueous solution, for example, an aqueous solution of 20% PVOH. When utilized, the PVOH is present in an amount of about 0.05 to about 5 wt % based on the entire weight of the bonding or binding agent composition.

The bonding or binding agent compositions of the invention may also contain other ordinary components, known in the art and in effective amounts, such as additional surfactants, neutralizers, initiators, biocides, defoamers and the like.

The bonding or binding agent compositions of the invention are in the form of an emulsion comprising water in an amount from about 15% to about 80%, or 30% to about 75%, by weight based on the total weight of the composition.

The bonding or binding agent compositions of the invention are added to soil in an effective amount to achieve the desired design specifications. For example the soil stabilizer may be added at a rate of 0.01 to about 10 wt % based on the weight of the soil.

The bonding or binding agent compositions are prepared by combining the first emulsion and the second emulsion to form a soil stabilizing or a soil modifying composition.

In order to provide a better understanding of the present invention including representative advantages thereof, the following examples are offered.

### EXAMPLES

Table A lists the components of a bonding or binding agent composition of the invention.

TABLE A
Formulation

| | wt % of Bonding |
|---|---|
| | or Binding Composition |
| 69.99 wt. % First Emulsion | |
| CascoWax EW 58LV¹ | 38.2 |
| Surfactant | 2.55 |
| water | 29.22 |
| 30 wt. % Second Emulsion | |
| Vinyl acetate | 11.9 |
| VeoVa 10 monomer² | 1.32 |
| PVOH | 0.74 |
| Initiator | .072 |
| Neutralizer | .054 |
| water | 15.83 |
| 0.008 wt % Defoamer | 0.008 |

¹Cascowax ™ EW 58LV is an aqueous emulsion containing approximately 54 w % weight of an LV slack wax commercially available from Momentive Specialty Chemicals Inc.
²VeoVa 10 monomer is the vinyl ester of neodecanoic acid commercially available from Momentive Specialty Chemicals Inc.

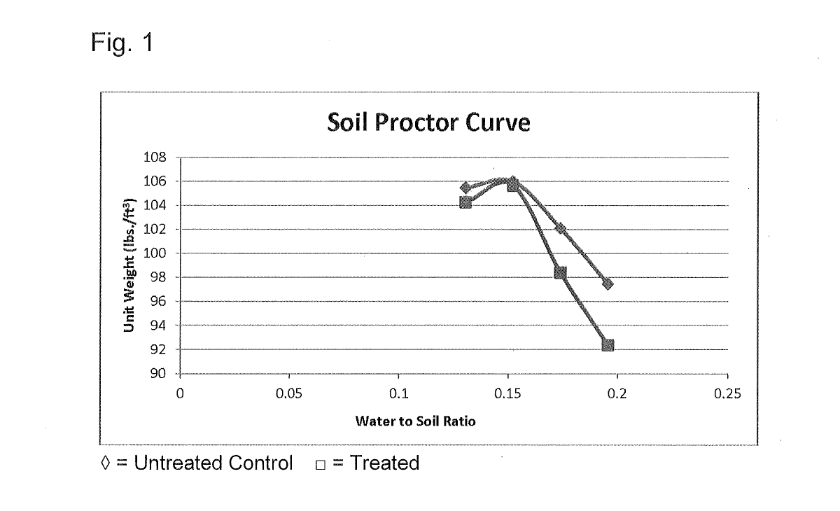

Example 1A. Samples were tested under ASTM D-698 (Standard Proctor Testing). Soil (relatively low Plastic Index clay) was oven dried for 24 hours and passed over a #4 screen to remove large particles. The soil was split into ten 2.3 kg samples. Four untreated (Control 1-4), and 4 treated samples (1-4), containing 1 wt % of the composition in Table 1, were mixed at various moisture contents and subjected to compaction and density measurements. The results appear in Table 1 below and FIG. 1.

TABLE 1
Results ASTM D-698 (Standard Proctor Testing)

| | Control 1 | Control 2 | Control 3 | Control 4 | 1 | 2 | 3 | 4 |
|---|---|---|---|---|---|---|---|---|
| Wm (lbs) | 4.464 | 4.464 | 4.464 | 4.464 | 4.464 | 4.464 | 4.464 | 4.464 |
| Weight of Proctor | | | | | | | | |
| Mold | | | | | | | | |
| Weight of Sample (lbs) | 4.041 | 4.166 | 4.119 | 4.038 | 3.996 | 4.153 | 3.97 | 3.827 |
| Wms (lbs) | 8.505 | 8.63 | 8.583 | 8.502 | 8.517 | 8.46 | 8.434 | 8.291 |
| Weight of Mold and | | | | | | | | |
| Sample | | | | | | | | |
| wt % Bonding/Binding | 0 | 0 | 0 | 0 | 0.7 | 0.7 | 0.7 | 0.7 |
| Agent based on Weight | | | | | | | | |
| of Sample | | | | | | | | |
| Water (mls) | 300 | 350 | 400 | 450 | 300 | 350 | 400 | 450 |
| Total Volume of Mold | 0.03 ft³ | 0.03 ft³ | 0.03 ft³ | 0.03 ft³ | 0.03 ft³ | 0.03 ft³ | 0.03 ft³ | 0.03 ft³ |
| % moisture of Sample, | 13.04% | 15.22% | 17.39% | 19.57% | 13.04% | 15.22% | 17.39% | 19.57% |
| Bonding/Binding | | | | | | | | |
| Agent and Water | | | | | | | | |
| Dry Density (lbs/ft³) | 105.43 | 105.97 | 102.09 | 97.45 | 104.25 | 105.64 | 98.40 | 92.36 |

The treated specimens, with this particular soil, showed no statistical difference in the density at optimal moisture. The treated samples exhibited a lower dry density which indicates the soil is more compactable than the untreated samples.

Example 1B. One control and one treated dried Proctor samples were submerged in water for 2 hours. The treated sample retained sufficient cohesion to allow removal of the sample from the water bath by hand. The untreated sample almost completely disintegrated during extraction from the water bath.

Example 2. Samples were tested under ASTM-4318 Part I: Plastic Limit. Soil was dried, pulverized and passed over a #40 sieve. Water was added to 4 soil samples (controls), and water plus 1 wt % of composition in Table 1 was added to 4 other soil samples (invention samples). The samples were hand-rolled using paper to blot excess moisture. Once plastic limit was reached, the samples were oven dried for 24 hours. Moisture content was determined. The average Plastic Limit of the 4 untreated control samples was 20%, and the average Plastic Limit of the 4 treated invention samples was 24%. Therefore, the treated inventive samples show an increase in stiffness at higher moisture contents.

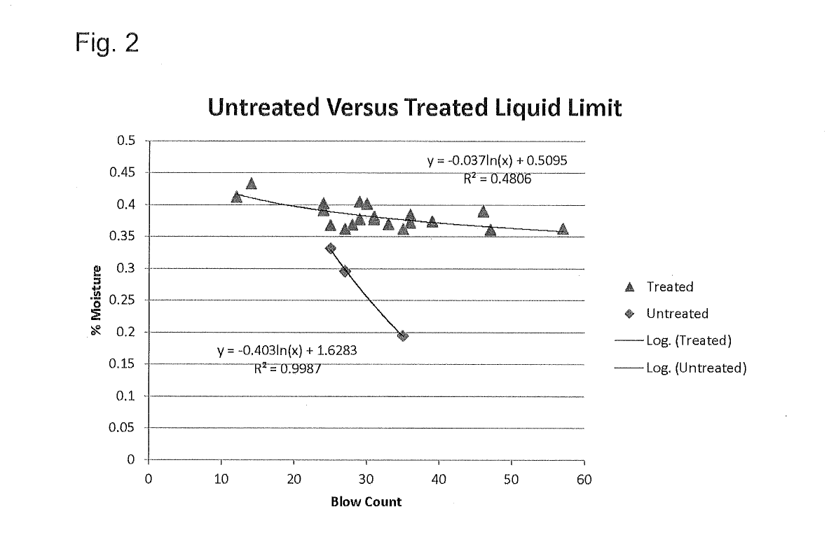

Example 3. Samples were tested under ASTM-D4318 Part II: Multipoint Liquid Limit (Method A). Soil was dried, pulverized and passed over a #40 sieve. Water was added to 4 soil samples (controls), and water plus 1 wt % of composition in Table 1 was added to 15 other soil samples (invention samples). Samples were subjected to testing by forming grooved soil pats in the Liquid Limit Device and dropped until the formed gap closed at a distance of 13 mm. Completed tests were oven dried for 24 hours. Moisture content was determined. The method was modified to include drop counts higher and lower than the standard for the treated samples. Results are shown in FIG. 2. The average Liquid Limit of the 4 untreated control samples was 33%, and the average Liquid Limit of the 15 treated invention samples was 38%. Therefore, the treated inventive samples exhibited elevated liquid limit and reduction in moisture sensitivity compared to the controls. These soil modifications are positive for both construction operations and long-term asset performance.

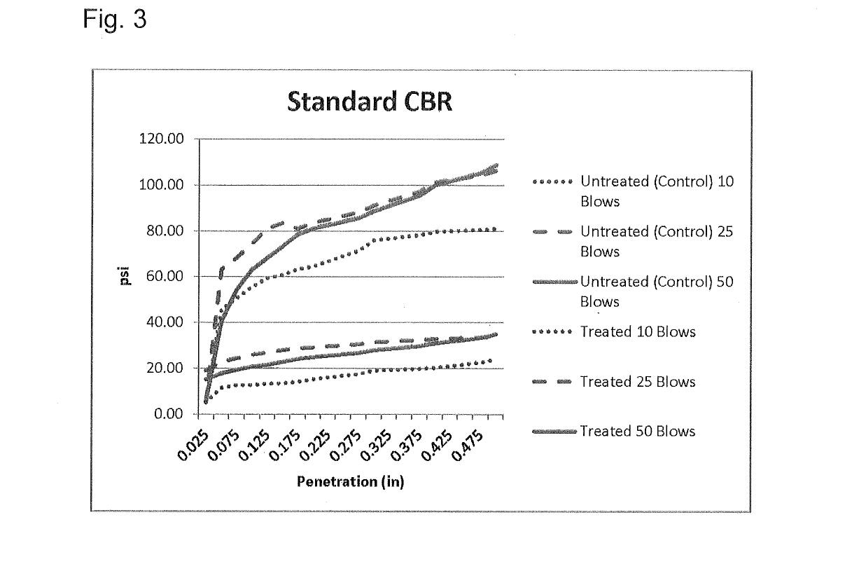

Example 4. Samples were tested under ASTM D 1883 (California Bearing Ratio) Part 1. The “Bearing Ratio at Optimum Water Content Only” method was used. Three samples each of untreated (control) and treated (invention 1 wt % of composition in Table 1) were compacted using 10, 25 and 50 blows per layer. Load was applied to the penetration plunger at the center of each sample at a rate of 0.05 in/min (0.127 cm/min). until a distance of 0.5 inches (1.27 cm) of penetration was achieved. The load effort was simultaneously recorded as a measure of plasticity. The results appear in FIG. 3.

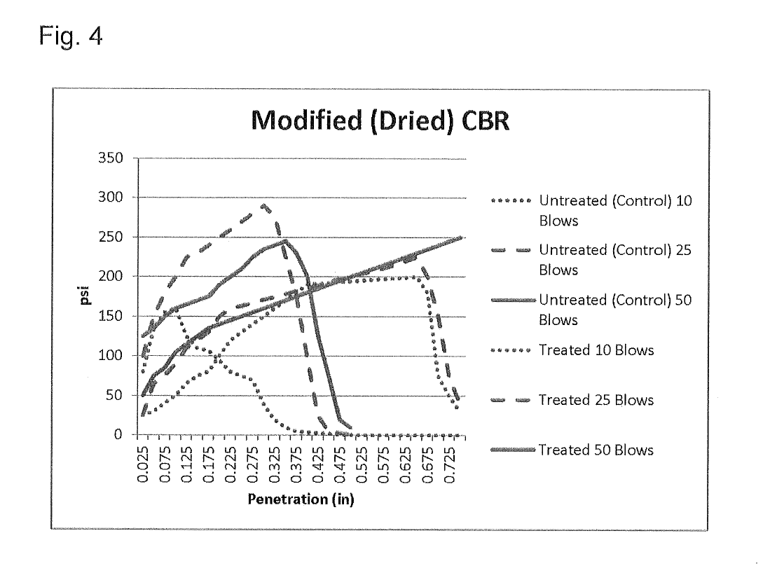

Example 5. Samples were tested under ASTM D 1883 (California Bearing Ratio) Part 2: Modified CBR. The previous penetration testing was repeated, but substituted samples compacted at optimum moisture and oven dried for 24 hours were tested. Samples were taken to failure rather than stopping at 0.5 inches (1.27 cm) with the exception of the 50 blow treated sample which accepted the entire length of the probe (0.75 inches, 1.91 cm) without failing. The results appear in FIG. 4. The treated specimens demonstrated a greater shear capacity to tack penetration without failure in the dried state.

Example 6. Samples were tested under ASTM D 2166 (Unconfined Compressive Strength). Treated specimens demonstrated a peak stress of 84.3 with a peak vertical deformation of 2.13 inches (cm) while the untreated specimens demonstrated a peak stress of 80.5 with a peak vertical deformation of 0.38 inches. Therefore, the treated specimens demonstrated a significant improvement in their stress/strain behavior. The probably result would be significant improvement in fatigue behavior for pavements and/or other layered structures.

While the present invention has been described and illustrated by reference to particular embodiments and examples, those of ordinary skill in the art will appreciate that the invention lends itself to variations not necessarily illustrated herein. For this reason, then, reference should be made solely to the appended claims for purposes of determining the true scope of the present invention.

I claim:

1. A bonding or binding composition for stabilizing or modifying soil as a sub-base comprising:
a first emulsion comprising a wax;
a second emulsion comprising a film forming polymer; and
water.

2. The bonding or binding composition of claim 1 wherein the first emulsion comprises one or more petroleum waxes, Montan waxes, synthetic waxes, animal waxes or vegetable waxes.

3. The bonding or binding composition of claim 1 wherein the first emulsion comprises a wax comprising one or more CnH2n+2 hydrocarbons, where n is an integer between 18 and 42.

4. The bonding or binding composition of claim 1 wherein the first emulsion comprises a straight chain hydrocarbon wax having an average chain length of 20 to 30 carbon atoms.

5. The bonding or binding composition of claim 1 wherein the first emulsion comprises a wax having an average chain length of 32 carbon atoms or greater.

6. The bonding or binding composition of claim 1 wherein the first emulsion comprises a wax having an average chain length of 22 to 45 carbon atoms.

7. The bonding or binding composition of claim 1 wherein the first emulsion comprises a wax derived from lubricating oil distillates.

8. The bonding or binding composition of claim 1 wherein the second emulsion comprises a monomer selected from the group consisting of vinyl acetate, vinyl proponate, vinyl butyrate, vinyl isobutyrate, vinyl 2-thylhexoanoate, vinyl laurate.

9. The bonding or binding composition of claim 1 wherein the second emulsion comprises a copolymer comprising a vinyl acetate monomer and a vinyl ester of a carboxylic acid monomer.

10. The bonding or binding composition of claim 9 wherein the vinyl ester of a carboxylic acid monomer may be one or more of a vinyl ester of a C2 to C12 carboxylic acid.

11. The bonding or binding composition of claim 1 wherein the second emulsion comprises a polyvinyl alcohol having a molecular weight (Mw) from about 13,000 to about 23,000.

12. A bonding or binding composition comprising:
about 10 to about 60 wt % wax based on the entire weight of the bonding or binding agent;
a film forming polymer comprising one or more of vinyl acetate, vinyl proponate, vinyl butyrate, vinyl isobutyrate, vinyl 2-thylhexoanoate, vinyl laurate monomers in an amount of about 5wt % to about 20wt % based on the entire weight of the bonding or binding agent composition;
optionally a polyvinyl alcohol having a molecular weight (Mw) from about 13,000 to about 23,000 in an amount of about 0.05 to about 5 wt % based on the entire weight of the bonding or binding agent composition; and
water.

13. A stabilized or modified soil comprising soil and the bonding or binding composition of claim 1.

14. The stabilized or modified soil of claim 13 comprising the bonding or binding composition in an amount of about 0.01 to about 10 wt % based on the weight of the soil.

15. A method for stabilizing soil comprising combining or contacting soil and the bonding or binding composition of claim 12.
